(19) United States
(12) Patent Application Publication
(10) Pub. No.: US 2009/0240555 A1
(43) Pub. Date: Sep. 24, 2009

(54) DYNAMIC INTERNET SHOPPING METHOD AND SYSTEM

(75) Inventor: Krishna Prasad Panje, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,198

(22) PCT Filed: Dec. 8, 2005
(86) PCT No.: PCT/IB2005/054134

§ 371 Date: Jun. 8, 2007

Related U.S. Application Data
(60) Provisional application No. 60/635,243, filed on Dec. 10, 2004.

(51) Int. Cl. G06Q 30/00; G06Q 10/00

(52) U.S. Cl. 705/10; 705/27

(57) ABSTRACT

(57) Previous shopping sequences' (8) factors (9)—such as shopping site (10,11) or the item considered for purchase—are collected (50) and stored (52) at a shopping portal (16). When a potential customer engages (56) in a present shopping sequence (13), the factors (9) thereof are compared (58) at a facility (17) to the factors (9) of the previous shopping sequences (8). If the factors of the present shopping sequence match those of any previous shopping sequence, substantially the same information (18) furnished to the previous customers is furnished to the potential customer.

The present invention relates to a dynamic internet shopping method and system. More particularly, the present invention relates to a method and system wherein the prior shopping activities of a potential customer and of other customers are determined and stored in a shopping portal. Information that is relevant to the same or a similar product or service that was investigated during the prior shopping activities is presented to the potential customer as a dynamic shopping portal if the potential customer's present shopping activities substantially match the prior shopping activities, thereby shielding the customer from irrelevant, annoying or unwanted information.

Persons in search of goods or services to purchase may conduct their search in a number of ways, including browsing websites and visiting stores, both of which are referred to herein as “browsing a shopping site.” Personalized dynamic websites are known, as is the use of cookies, user purchasing history, and user geographic location to construct and determine the content of such websites. See U.S. Pat. No. 6,782,370 to Stack, issued Aug. 24, 2004 (“Stack”), US Published Application 2003/0105682 A1 to Dicker, et al., published Jun. 5, 2003 (“Dicker”), and European Published Application EP 1 315 111 A2 to Matsushita, published May 28, 2003 (“Matsushita”).

Browsing a shopping site over the internet (“website browsing”) may be achieved via a PC or a laptop computer (collectively “computer”); via a Personal Data Assistant (“PDA”), a term which herein means a portable device, such as a pocket PC, a handheld computer, a palm top computer, or similar devices, whether stylus- or keyboard-operated; or via a mobile (or cell) telephone. When a potential customer browses a shopping website, there may be presented a webpage containing many details of numerous products or services offered on the site. In order to focus on the product or service that is to be purchased, the customer must, by trial and error, make numerous selections until an item generally corresponding to the one sought is identified. Following this, the identified item may be examined in detail. The examination may lead the customer to purchase the item; otherwise, the process may be iterated or terminated. The foregoing may irritate the customer if there are a large number of choices—many of them irrelevant to the customer—or if the viewing screen is small, as is the case with PDAs, requiring frequent vertical and horizontal scrolling. Moreover, this hit-or-miss process consumes bandwidth.

Browsing a shopping site by in-store browsing is similar to the foregoing, sometimes possibly requiring less time because of real time interactions between the customer and store personnel.

“Push” ads—ads not requested by the customer—are often presented to potential customers who browse websites and stores. Virtual shopping push ads on internet websites typically include pop-ups and icons inviting the customer to visit other websites. In-store browsing also exposes the customer to push ads, such as displays and notices. Push ads, most of which are usually for products or services other than that which the customer desires to purchase, constitute a further customer irritant and extend the time of the shopping search.

The present invention contemplates streamlining a potential customer's virtual and physical browsing for items that may be purchased by taking into account the “context” of the potential customer, and of any other customer, who has previously specifically considered purchasing or (more significantly) purchased, an item that is similar to, or the same as, the item the potential customer presently seeks. This context includes those selected circumstances and factors that were applicable when the prior specific consideration or purchase occurred. The terms “context” and “shopping sequence” are used herein synonymously.

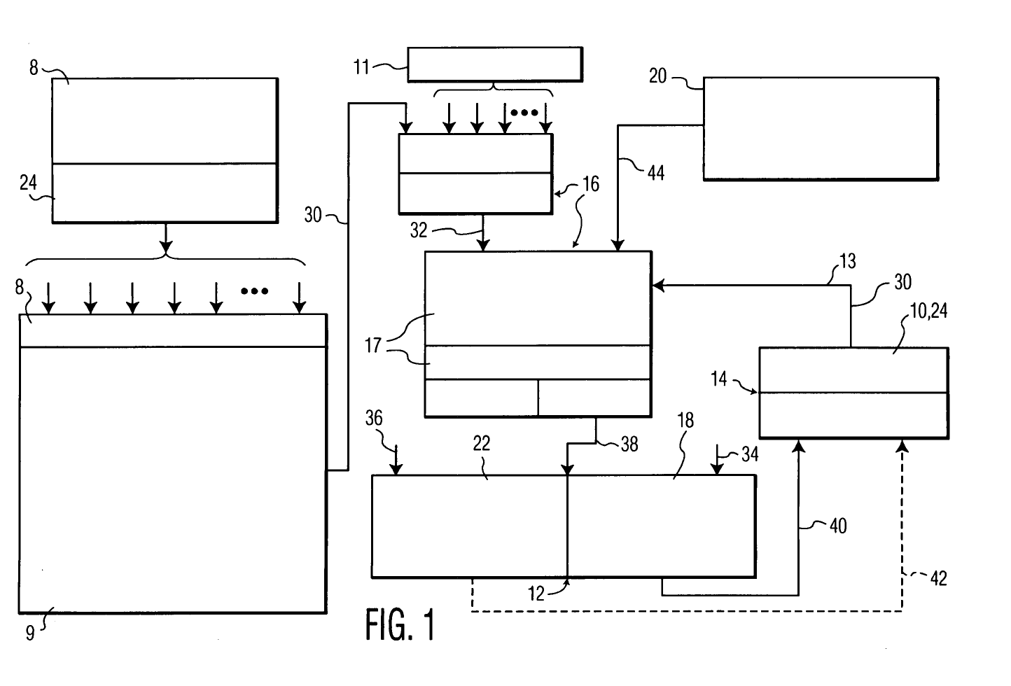

FIG. 1 is a diagrammatic and schematic representation of a dynamic internet shopping system according to the present invention for effecting the method of the present invention.

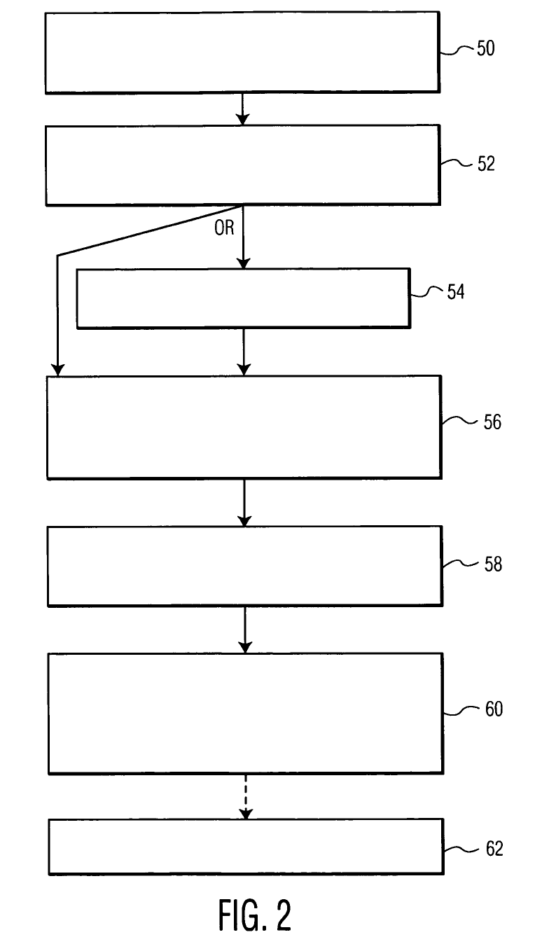

FIG. 2 is a flow sequence of a dynamic internet shopping method according to the present invention.

A functional description of the method (FIG. 2) of the present invention and of a generalized system or network (FIG. 1) for performing the method is set forth below. In this description, several definitions are applicable in the context of the present invention.

The term “pushed ad” means information, such as a web page or ad, that is presented to a user, e.g., on a computer or mobile device screen, without the viewer's request. One type of pushed ad is a “pop-up,” an unrequested ad appearing before, during, or after the viewing of an intentionally visited website. Another type is an ad sent by e-mail without the request of the addressee following the addressee's visiting a web site. A further type of pushed ad is an unrequested ad and other information displayed in a store.

“GPS or Global Positioning System,” “A-GPS or Assisted Global Positioning Services,” and “EOTN or Enhanced Observed Time Difference” all refer to systems which perform trilateration (or other topographical operation) in three-dimensional space to locate, e.g., by longitude and latitude, a point on the earth. GPS and A-GPS calculate the point on the earth by calculating the distance from the point to three or more earth-orbiting satellites. EOTN is similar, but calculates the distance from the point to three or more cellular base stations.

“OMA or Open Mobile Alliance” and “WAM or Wireless Application Protocol,” now jointly functioning under OMA, promote and set standards for protocols that permit Internet content to be displayed on various wireless devices, such as cell or mobile phones. As the name implies, “MMS or Multimedia Messaging Service” relates to protocols that permit all types of Internet content—photos, movies, audio and other media forms—to be displayed on devices such as mobile phones.

Referring first to FIG. 1, a “Shopping Sequence” 8 or “context” comprises a series of factors 9 relating to or arising out of the activities (“shopping sequence”) of a potential customer at a shopping site 10—a virtual location (a shopping site on the internet) or a physical location (a shopping site comprising a store)—who purchases or who is likely to purchase a product or service. The present invention contemplates using a combination of selected factors 9 derived from the prior shopping sequence(s) 8 of the potential customer and/or from the prior shopping sequences 8 of a number of other customers at the shopping site 10 and/or at other shopping sites 11 to determine information 12 that will be presently furnished to the potential customer when one or more internet shopping sites 10,11 are subsequently browsed thereby or when the potential customer subsequently browses in a store shopping site 10. The furnishing of the relevant information 12 to the potential customer during a present shopping sequence 13 renders the website or store 10 browsed by the potential customer a “dynamic shopping site” 14.

The selected factors 9 comprising each relevant prior shopping sequence 8 are stored in a shopping portal 16. Thereafter, when the potential customer presently browses the internet or a store 10, selected, relevant, stored prior shopping sequences 8 having factors 9 substantially similar to the factors related to the potential customer's present shopping sequence 13 are used as filters or maps 17 by the shopping portal 16 to identify similar prior shopping sequences 8. Furnished to the potential customer at the dynamic shopping site 14 are ads and other information 18 that were either previously furnished (to the potential customer or other customers), or that are similar to the previously furnished information, when the selected factors 9 of the prior shopping sequences 8 arose.

Various factors 9 may be selected and weighted or differentiated at the discretion of the seller(s) of the goods or services or of the seller(s)-designated third party. For example, the following factors 9 may be considered significant:
(1) The time (e.g., terrestrial time and/or day) when the potential customer
   or other customers sought specific information from the internet (virtual location) or at a store (physical location)—The time factor may be weighted or differentiated. For example the seller may determine that the fact that information was sought during leisure time—weekends, after 8:00 PM, holidays—is more significant than the seeking of information during normal working hours, the former being given high weight and the latter being given little or no weight, or vice versa.
(2) The location of the potential customer or other customers when the specific information was sought—Such locations include the customer's home when the internet is accessed on a PC or laptop; the customer's home when the internet is accessed by a mobile device; a non-home location when the internet is accessed by a mobile device, such as on the road, in a shopping center, in front of a particular store, or in a store; in a store when information is obtained from its personnel. Again, the seller, or the seller-designated third party, may give much weight to particular locations and little or no weight to others.
(3) The nature of the source (or shopping site) from which information was previously sought—This factor may involve contrasting and differentiating, for example, a general retail store, which sells lawn tractors, and a specialized farm equipment store. Specifically, a retail store may choose to present information about its lawn tractors, even though prior activity (of the potential customer and/or other customers) related to a farm equipment store, on the theory that the potential customer may feel that a lawn tractor is a lawn tractor, regardless of its point of sale. A farm equipment store may choose to not present information about its lawn tractors where the prior activity related to a retail store, on the theory that the potential customer will not be interested in its more robust, but much more expensive, lawn tractors.
(4) The type of information sought by the potential customer or other customers from the internet or from store personnel, that is, the product or service concerning which the information was sought—This factor will typically be given much weight, as one goal of the present invention is to furnish the potential customer only with information relevant to his wishes and to not furnish, and thereby not annoy, the potential customer with irrelevant data. However, the factor covering information type may be weighted or differentiated similar to factor (3). For example, if a potential customer or other customers have sought information concerning a particular brand of wrist watch, one seller may choose to present to the potential customer only information pertaining to that brand, while another seller may choose to present information about several brands of watches in the same price range as the particular brand.
(5) Whether the potential customer or other customers have previously purchased the product or service of interest—The seller may view this factor as neutral when no purchase has been previously made, but may view a completed purchase as a weighty factor. Obviously, where a significant number of customers have previously consummated purchases of the relevant product or service, and where the present potential customer's other activities or factors match those of previous purchasers, there is a higher likelihood that the potential customer presented with information about the item will purchase it.

As noted, in the foregoing and the following, the potential customer is assumed to be presently seeking to obtain information either indirectly from the shopping portal 16—that is, from a shopping site 10, such as a website (a virtual location) on the internet or a store (a physical location) or directly from the shopping portal 16. Shopping sites 10 can access, over the internet, the shopping portal 16, which has stored the relevant prior factors 9. The shopping portal 16 (factor-storage facility) may be centrally located (or comprise a number of storage facilities tied together) and/or shared by numerous sellers, and/or operated by a seller(s)-designated third party, although some sellers may choose to maintain, or have maintained, a shopping portal 16 for their sole access, or for access by only selected other sellers.

A functional description of the present invention immediately follows.

Assume that a potential customer A (or another customer) has previously accessed a travel-related website (virtual shopping site) of X from his home on a weekend night, browsing for weekend tours. His shopping sequence may be viewed as comprising Factor1 (“F1”), the time of his activity (a weekend night); Factor2 (“F2”), his location (at home); Factor 3 (“F3”), the website type (travel-related); and Factor4 (“F4”), his target product or service (weekend tours). The customer may book and pay for a weekend tour, Factor F5₁, or he may decline doing so, Factor F5₂. Two possible shopping sequences (“SS”) are thus produced: SS₁=F1+F2+F3+F4+F5₁ and SS₂=F1+F2+F3+F4+F5₂, both of which are stored in the Shopping Portal.

Now assume that A accesses the same website 10 or the shopping portal 16 several weekends later. In response to this access, or current shopping sequence 13, the shopping portal 16 may, depending on weighting or differentiation by the seller or the seller-designated third party, as indicated at 20, use either or both SS₁ or SS₂ to initially display at the dynamic shopping site 14 information 18 regarding various similar tours. The shopping portal 16 may use the weighting or differentiation 20, at the discretion of the seller. That is, SS₁ may result in displaying only the information 18 concerning weekend tours having similar content and pricing to that purchased as a result of SS₁, and in displaying similar information 18 concerning weekend tours of varying contents and prices as a result of SS₂. Further, customer A may be directed to, or the website may display by “pushing,” content 22 from the seller or from another seller, say Y, which contains information regarding F4, weekend tours generally.

Additionally, assume that customer B has previously accessed X's and/or Y's or others' travel-related websites from home during a weekend. This similarity in A's and B's shopping sequences—both include at least F1+F2+F3+F4—may lead the seller to assume some commonality in the wishes and attitudes of A and B. Accordingly, when A accesses X's website 10, he may be shown a dynamic shopping site 14 that includes information 18 on websites previously visited by B during a similar shopping sequence 8. Again, the weighting or differentiation 20 may be used. For example, a tour that B purchased (F5₁) may be “pushed” or prominently presented to A, while other tours that B examined, but did not purchase, Factor F5₂, may be less prominently presented, or not presented at all, to A.

The present invention contemplates that a potential customer may access the shopping portal 16 either directly or indirectly via the shopping site 10 that comprise websites using facilities 24, such as (a) personal or laptop computers or (b) mobile or hand-held devices—such as telephones and PA's, or the like. Preferably mobile or hand-held devices used in the present invention are WAP/OMA-compliant and may be MMS-compliant.

If the potential (and other) customer's location, F2, is deemed significant in defining a shopping sequence 8 or 13—as might well be the case where a virtual shopping site has been browsed while the potential customer is standing in front of the display window of a physical shopping site—either a computer or a mobile device 24 may yield F2 (potential customer's location) for storage in the shopping portal 16. Specifically, facilities and systems for determining the physical location of a computer user are known. See, for example, U.S. Pat. No. 6,757,740 to Parekh et al., issued Jun. 29, 2004. The location of the user of a hand-held or mobile device may be determined by including appropriate GPS, A-GPS, DGPS, EOTN, or similar capabilities therein.

The time of the potential customer's activity, factor F1, is routinely available from a computer or a mobile device, all 24 of which contain internal clocks. Similarly, by well known techniques, factors F3-F5 (the shopping sites previously visited, the product or service sought, and whether or not a sale was consummated) may be easily collected and then stored in the shopping portal 16.

The present invention also contemplates that factors F1-F5 may be derived from prior activity at a shopping site 10 that comprises a store. In this event, the relevant factors 9 may be determined by store personnel who subsequently tabulate and cause them to be stored in the shopping portal 16, for example by manual entry using in-store facilities 24 connected thereto.

Those skilled in the art will appreciate that other factors 9 related to prior shopping sequences 8 of the potential customer and other customers may be collected and stored in the shopping portal 16. Such additional factors 9 may include price or price range, brand name, apparent credit worthiness (e.g., where a prior sale was consummated and paid for with a valid credit card), and the customer's age and sex.

The factors 9 comprising the prior shopping sequences 8 and the present shopping sequence 13 may be collected by the facilities 24 at the present shopping site 10 and at other shopping sites. This facilities 24 may be connected to the shopping portal 16 by a dedicated path or circuit or (preferably) via the internet, both indicated at 30. The storing of the previous factors 9 and the comparing of these factors 9 with those of the present shopping sequence 13 may be performed in the shopping portal 16 as an integrated facility, or the shopping portal 16 may comprise separate facilities linked by the internet or otherwise, as shown at 32. Similarly, the information 18,22 may be entered by the seller(s), via the internet or otherwise as indicated at 34 and 36, into the facility 12, which may form an element of the shopping portal 16 or constitute a separate entity linked to the shopping portal 16 via the internet or otherwise, as indicated at 38. The information 18 and 22 may be transmitted to the dynamic shopping site 14 by the internet or otherwise, as indicated at 40 and 42. Seller factor-selecting, -weighting, and -differentiation 20 may be similarly linked to the comparison/matching facility 17, as indicated at 44.

Referring now to FIG. 2, there is shown a general flow diagram of the method according to the present invention.

At Step 50, the factors 9 of previous shopping sequences 8 at one or more shopping sites 10,11 are collected, and at location 52 these factors 9 are stored at the shopping portal 16. At Step 54 the seller or the seller-designated third party selects, weights and differentiates those previous factors 9 that are felt to be significant. At Step 56, the factors 9 of the potential customer's present shopping sequence 13 are collected as the potential customer browses the shopping site 10 or the portal 16. At Step 58 the factors 9 of the present shopping sequence 13 are compared at the portal 16 to the stored seller-selected, -weighted, and -differentiated factors 9. At Step 60, when the selected factors of one or more of the previous shopping sequences 8 substantially match the same factors of the present shopping sequence 13, the same or similar information 18 furnished during the previous shopping sequence 8 is presented to the potential customer at the present shopping site 10, now transformed into the dynamic shopping site 14. Optionally, the information 18 may be accompanied or supplemented by pushed ads or similar information 22.

The foregoing description shall not limit the present invention to the precise form thereof as described. Further, those ordinarily skilled in the field of this invention will appreciate that variations and modifications of the present invention, as described above, may be effected without departing from the spirit hereof. Such variations and modifications are covered by the following claims.

1. A method of presently recommending goods or services to a potential customer over a distributed network, comprising:
(a) detecting and storing selected factors of a previous shopping sequence of the potential customer and/or of one or more other customers, the previous shopping sequence(s) having occurred at a shopping site or sites and having resulted in the furnishing of selected information thereat;
(b) in response to the potential customer presently engaging in a shopping sequence at a present shopping site, comparing selected stored factors of the previous shopping sequence(s) to corresponding factors of the present shopping sequence; and
(c) furnishing to the potential customer only information that is substantially the same as that which was furnished during those previous shopping sequence(s) which had selected factors that are substantially matched by the corresponding factors of the present shopping sequence.

2. A method as in claim 1, which further comprises:
(d) weighting and differentiating the selected stored factors to selectively affect the content and amount of the furnished information.

3. A method as in claim 1, which further comprises:
in step (c), furnishing to the potential customer additional information that is generally similar to the furnished information.

4. A method as in claim 3, which further comprises:
weighting and differentiating the selected stored factors to selectively affect the content and amount of the furnished information and the additional information.

5. A method as in claim 1, wherein:
the selected stored factors include at least the identification of the goods or services that were the subject of the previous shopping sequence(s) and the identification of the previous shopping site.

6. A method as in claim 5, wherein:
the stored factors also include at least the location of the customer(s) during the previous shopping sequence(s).

7. A method as in claim 6, wherein:
the selected stored factors also include one or more of the following: the time and/or day during which the previous shopping sequence(s) occurred; whether or not the goods or services involved in the previous shopping sequence(s) were purchased; the price or price range of the goods or services involved in the previous shopping sequence(s); the brand(s) of the goods or services involved in the previous shopping sequence(s); if the goods or services involved in the previous shopping sequence(s) were purchased, whether payment was in cash or by credit card; the age and/or sex of the customer(s) involved in the previous shopping sequence.

8. A method as in claim 1, wherein:
the shopping sites are virtual or physical, and
at least some of the steps are carried out via the internet.

9. A method as in claim 8, wherein:
at least one of the steps is performed via a computer, a PDA, a mobile telephone or manual entry.

10. A method as in claim 1, wherein:
at least one of the steps is performed via a computer, a PDA, a mobile telephone or manual entry.

11. A system for presently recommending goods or services to a potential customer over a distributed network, comprising:
(a) facilities for detecting and storing selected factors of a previous shopping sequence of the potential customer and/or of one or more other customers, the previous shopping sequence(s) having occurred at a shopping site or sites and having resulted in the furnishing of selected information thereat;
(b) facilities responsive to the potential customer presently engaging in a shopping sequence at a present shopping site for comparing selected stored factors of the previous shopping sequence(s) to corresponding factors of the present shopping sequence; and
(c) facilities for furnishing to the potential customer only information that is substantially the same as that which was furnished during those previous shopping sequence(s) which had selected factors that are substantially matched by the corresponding factors of the present shopping sequence.

12. A system as in claim 11, which further comprises:
(d) facilities for weighting and differentiating the selected stored factors to selectively affect the content and amount of the furnished information.

13. A system as in claim 11, wherein:
the information-furnishing facilities include facilities for furnishing to the potential customer additional information that is generally similar to the furnished information.

14. A system as in claim 13, wherein:
the information-furnishing facilities include facilities for weighting and differentiating the selected stored factors to selectively affect the content and amount of the furnished information and the additional information.

15. A system as in claim 11, wherein:
the detecting and storing facilities detect and store at least the identification of the goods or services that were the subject of the previous shopping sequence(s) and the identification of the previous shopping site.

16. A system as in claim 15, wherein:
the detecting and storing facilities further detect and store at least the location of the customer(s) during the previous shopping sequence(s).

17. A system as in claim 5, wherein:
the selected stored factors also include one or more of the following: the time and/or day during which the previous shopping sequence(s) occurred; whether or not the goods or services involved in the previous shopping sequence(s) were purchased; the price or price range of the goods or services involved in the previous shopping sequence(s); the brand(s) of the goods or services involved in the previous shopping sequence(s); if the goods or services involved in the previous shopping sequence(s) were purchased, whether payment was in cash or by credit card; the age and/or sex of the customer(s) involved in the previous shopping sequence.

18. A system as in claim 11, wherein:
the shopping sites are virtual or physical, and
at least some of the facilities include or are connected to the internet.

19. A system as in claim 18, wherein:
at least one of the facilities includes or is connected to a computer, a PDA, a mobile telephone or manual entry apparatus.

20. A system as in claim 11, wherein:
at least one of the facilities includes or is connected to a computer, a PDA, a mobile telephone or manual entry apparatus.
